(19) United States
(12) Patent Application Publication
(10) Pub. No.: US 2013/0307714 A1
(43) Pub. Date: Nov. 21, 2013

(54) Passive Millimeter Wave Imaging System with Environmental Control for Concealed Object Detection

(71) Applicant: MVT Equity, LLC, (US)

(72) Inventors: Thomas D. Williams, Shutesbury, MA (US); Timothy D. Sullivan, Northampton, MA (US); Donald T. Verrastro, Pelham, MA (US); Nitin Madhuaudan Vaidya, Shrewsbury, MA (US)

(73) Assignee: MVT Equity, LLC, South Deerfield, MA (US)

(21) Appl. No.: 13/886,887

(22) Filed: May 3, 2013

Related U.S. Application Data
(60) Provisional application No. 61/642,256, filed on May 3, 2012.

(51) Int. Cl. G01S 13/89

(52) U.S. Cl. CPC G01S 13/89
USPC 342/1; 342/176

(57) ABSTRACT

Embodiments of the present innovation relate to a system and technique for passive millimeter wave imaging for concealed object detection. In one arrangement, millimeter wave imaging is provided in conjunction with an environment which is, radiometrically, at a lower temperature than the human subject. In one arrangement, the environment is configured as part of a system wherein the subject may easily pass into the system for scanning and then out of the system. Size of the overall system is minimized. Furthermore, the system includes a structure configured with sufficient strength to withstand reasonable abuse but, at the same time, is substantially transparent to the radiometric wavelengths being employed.

### RELATED APPLICATIONS

This patent application claims the benefit of U.S. Provisional Application No. 61/642,256, filed on May 3, 2012, entitled, “Passive Millimeter Wave Imaging System with Environmental Control for Concealed Object Detection,” the contents and teachings of which is hereby incorporated by reference in its entirety.

### BACKGROUND

Millimeter waves are electromagnetic radiation characterized by wavelengths in the range of from 1 to 10 millimeters and having corresponding frequencies in the range of 300 GHz to 30 GHz. Millimeter waves have the capability of passing through some types of objects which would otherwise stop or significantly attenuate the transmission of electromagnetic radiation of other wavelengths and frequencies. For example, millimeter waves pass through clothing with only moderate attenuation. Additionally, as millimeter waves occupy only a part of the electromagnetic spectrum, millimeter waves can reveal objects concealed on humans because clothing is, for the most part, transparent at these wavelengths. Accordingly, millimeter wave imaging has been employed to detect contraband and weapons concealed beneath clothing of an individual, for example.

According to known laws of physics, the amount or intensity of electromagnetic energy emitted by an object is proportional to its physical temperature measured in degrees Kelvin. The radiation originates from thermally-induced effects. These effects account for a distribution of radiation throughout a broad spectrum of frequencies, as recognized by Planck's Law. Consequently, it is typical to characterize the amount of energy emanating from a point or object in a scene by its apparent brightness temperature. The energy emanating from a point or object in the scene results from emission and reflection. Emission and reflection are related to one another such that highly emissive objects are only slightly reflective, and highly reflective objects are only slightly emissive.

In conventional forms of detection, either naturally occurring radiation, instrument provided radiation, or some combination is employed in the detection process. For example, conventional techniques for revealing concealed objects generally fall into two categories: active and passive. Passive millimeter wave imaging creates an image from both the emitted and the reflected electromagnetic energy. In passive millimeter wave (and other wavelengths in general) imaging for concealed object detection on people, the natural radiation from the person and the generally lower temperature environment in which the person is immersed cause a reflective object on that person to reveal itself in contrast because the object reflects a lower temperature than the body radiates. Active millimeter wave imaging typically relies only upon reflection by illuminating the scene with added energy and by observing contrast or distinction in energy emanated from different points within the scene, primarily reflections of the added energy. Combinations of active and passive approaches are possible.

### SUMMARY

Passive thermal images, including millimeter and other wavelengths, provide benefits in practical and safe detection of concealed objects on people. However, conventional passive millimeter wave imaging suffers from a variety of deficiencies. For example, because passive millimeter wave imaging relies on the inherent natural energy emanating from the objects and the background in the scene, and because such inherent natural energy is generally less than the amount of energy resulting from actively illuminating the scene with added energy, it is typically more difficult to create an image passively than actively.

Additionally, the geometric configuration of conventional passive millimeter wave imagers further limits the creation of accurate images that allow detection of concealed objects. For example, FIGS. 1A and 1B illustrate a conventional passive millimeter wave imaging system 10 which defines a generally lower temperature environment relative to a subject 12. As shown, the subject 12 enters a walkway 14 defined by the system 10 and a detector, such as a camera, (not shown) generates an image of the subject 12 based upon the emitted and the reflected electromagnetic energy relative to the subject 12. However, based upon the positioning of the subject 12 and geometry of the conventional passive millimeter wave imaging system 10, the walkway 14 provides a relatively large area where the subject 12 can be exposed to a room temperature environment (i.e., an environment having a generally higher temperature than the system 10). For example, the first and second side walls 16, 18 and the rear wall 20 of the system define a relatively large open area 22. This open area 22 can allow various uncontrolled aspects of the external environment to affect the passive millimeter wave detection, and resulting image, of the subject 12.

Various methods and apparatus are currently employed for the purpose of improving contrast by providing illumination sources. However, many of these techniques suffer from sensor-overload and uneven illumination when applied in a practical system.

Furthermore, it is unadvisable for safety reasons to radiate human subjects if it is not required in order to achieve detection.

Accordingly, there is a need for a system and technique in which passive thermal images may be used for practical and safe detection of concealed objects on people. For example, herein the thermal (specifically the radiometric) environment in which the subject is immersed can have a controlled and preferably even temperature that is significantly greater than that of the human being imaged. However, provision of a significantly higher than human temperature environment, although it may be effective at revealing concealed objects by providing sufficient contrast, suffers from various technical difficulties associated with safety of various heating methods. Furthermore, provision of significantly higher than human temperature environment means that the energy impinging upon the subject is greater than under normal circumstances, and therefore questions about electromagnetic radiation safety for the subject being scanned comes under question.

By contrast to conventional millimeter wave imaging, embodiments of the present innovation relate to a system and technique for passive millimeter wave imaging for concealed object detection. In one embodiment of the innovation, millimeter wave imaging is provided in conjunction with an environment which is, radiometrically, at a different temperature than the human subject, such as a lower temperature, and which substantially surrounds the subject. In one arrangement, the environment is configured as part of a system wherein the subject may easily pass into the system for scanning and then out of the system. Size of the overall system is minimized. Furthermore, the system includes a structure configured with sufficient strength to withstand reasonable abuse but, at the same time, is substantially transparent to the radiometric wavelengths being employed.

Methods and apparatus for the detection of primarily reflective objects are disclosed herein wherein those objects may attain any physical temperature, including that of the human subject. In one embodiment of the system, the environmental temperature is controlled to a temperature range of approximately 40° F., although other temperatures from slightly below human surface temperature to even lower temperatures can also work. The system can include a passive millimeter wave sensor, such as a camera, disposed in electrical communication with a display configured to display images of the subject under the radiometric temperature condition of the environment. The disclosed system and technique can be implemented in a manner which does not increase the electromagnetic energy in the environment beyond that of the normal thermal environment at any and all wavelengths, and is therefore a passive sensor. The system is configured to maximize the likelihood of detection of concealed or reflective objects by maximizing the angles over which objects may present themselves to the sensor and still provide detectable contrast while allowing easy ingress and outflow of subjects in a realizable structure. This system can incorporate other image modalities and devices not described herein. In one arrangement, the system can be fitted with image processing software for automatic detection of concealed objects and can be configured to provide or enhance privacy of the subjects.

In one arrangement, an imaging system includes a sensor and an environment disposed in proximity to the sensor. The environment includes a first wall extending from a sensor location and a second wall extending from the sensor location, the second wall opposing the first wall, the first wall and the second wall defining, and substantially surrounding, a subject imaging location disposed at a focal distance from the sensor. The environment includes a third wall disposed at a distal location relative to the first wall and the second wall and opposing the sensor, the third wall defining a subject walk space relative to the first wall and the second wall. The first wall, the second wall, and the third wall are configured to provide a thermal environment having an environmental temperature, the environmental temperature being distinct from a subject temperature.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1A illustrates a perspective view of a conventional structure of a conventional imaging system;

FIG. 1B illustrates a top view of the conventional structure of the imaging system of FIG. 1A;

FIG. 2A illustrates the radiometric nature of a black body exhibiting the property of emission of electromagnetic radiation;

FIG. 2B illustrates the radiometric nature of a mirror body exhibiting the property of reflection of electromagnetic radiation;

FIG. 2C illustrates the radiometric nature of a grey body exhibiting the properties of emission, reflection, and attenuation of electromagnetic radiation;

FIG. 2D illustrates the radiometric nature of a clothing exhibiting primarily the property of attenuation of electromagnetic radiation;

FIG. 3 illustrates an ideal radiometric environment for passive millimeter wave imaging in which the entire subject is immersed in a sphere of constant and even temperature, such as a temperature lower than that of the body;

FIGS. 4 illustrates a reduction from the ideal radiometric environment of FIG. 3 by use of a mirrored floor;

FIG. 5 illustrates a modification of the environment of FIG. 4 where the environment defines an opening through which the subject may enter and leave;

FIG. 6 illustrates the use of a wall with the environment of FIG. 5 to limit the sensor from detecting background clutter and to provide a general direction of flow so the subjects may enter and leave the scanning area;

FIG. 7 illustrates a schematic depiction of a passive millimeter wave imaging system, according to one arrangement;

FIG. 8 illustrates a perspective view of a passive millimeter wave imaging system, according to one arrangement;

FIG. 9 illustrates an exploded view of the passive millimeter wave imaging system of FIG. 7, according to one arrangement;

FIG. 10 illustrates the passive millimeter wave imaging system of FIG. 7 in use, according to one arrangement;

FIG. 11 illustrates examples of imaging pathways whereby a sensor of the passive millimeter wave imaging system detects objects by virtue of the fact that they reflect from the shield surfaces;

FIG. 12 illustrates an image output of the passive millimeter wave imaging system showing a concealed object;

FIG. 13A illustrates a wall of the system of FIG. 8, according to one arrangement; and

FIG. 13B illustrates the various layers of material which may be employed to construct a radiometrically controlled wall of FIG. 13A, according to one arrangement.

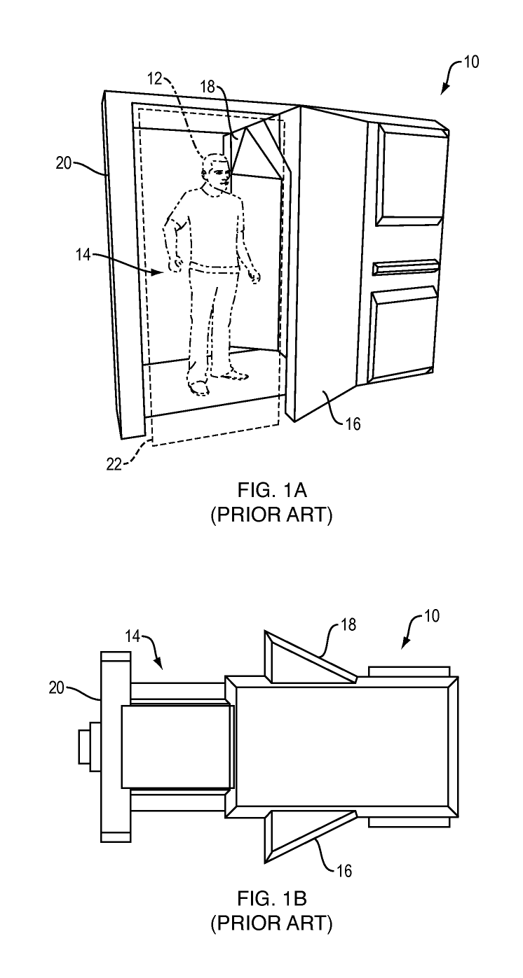

### DETAILED DESCRIPTION

The disclosed system and technique relate to passive millimeter wave imaging for concealed object detection, and more generally, to the use of any wavelength, where the subject is essentially illuminated by the environment, and in which the thermal properties, specifically the radiometric properties of that environment are employed to improve performance. In one embodiment, the subject is placed in a thermal environment which is normally at some temperature below human skin temperature. The subject does not sense this lower-than-normal temperature because the subject is insulated from the low temperature environment at wavelengths that the subject normally senses temperature (infrared). The geometry of the environment as well as the lower-than normal temperature of the system's environment increases the imaging contrast between the subject and concealed or reflective objects carried by the subject to maximize the likelihood of detection of the objects.

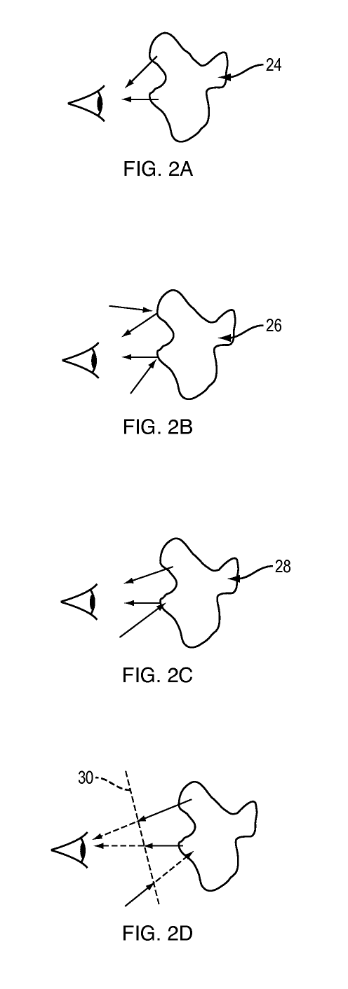

FIGS. 2A through 2D illustrate the radiometric nature of a variety of objects. As shown in FIG. 2A, according to well-established principles of physics, perfectly emitting objects 24 or so-called “black bodies” absorb and emit energy and are at thermal equilibrium and, as such, do not reflect any energy impinging upon them. The power which is received by observing such an object is directly proportional to that object's temperature. FIG. 2B, illustrates a mirror 26, or highly reflective object. The mirror only displays a temperature of the environment or objects which it is reflecting toward the observer. It is impossible to remotely measure the temperature of a perfect mirror. FIG. 2C illustrates a “gray body” 28. The vast majority of real objects are gray bodies, in that they have properties which are a mixture of emissions and reflections. Therefore, an observation of the power received from such an object is a mixture of the temperature of that object according to the emission quality of that object and the temperature of that object, and the temperature of the environment or other objects according to its reflection. As indicated in FIG. 2D, some objects can slightly reduce imaging contrast and are substantially transparent to electromagnetic radiation, such as clothing 30 at millimeter wavelengths.

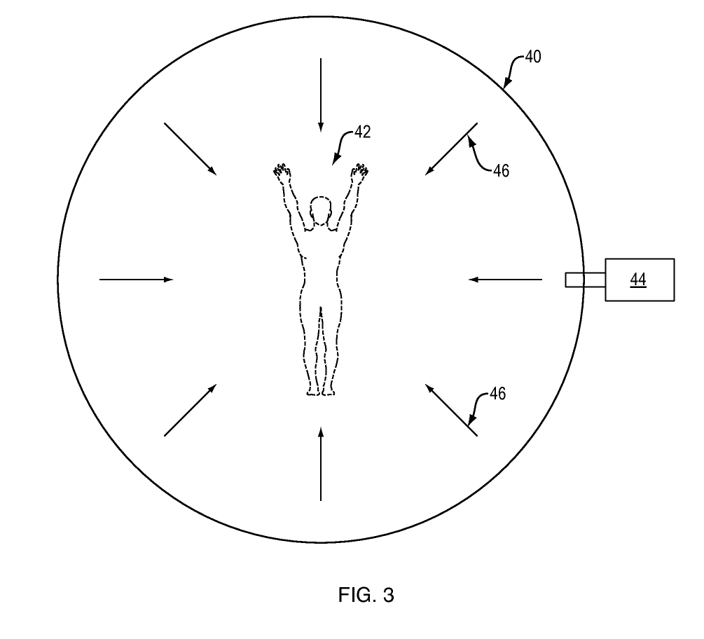

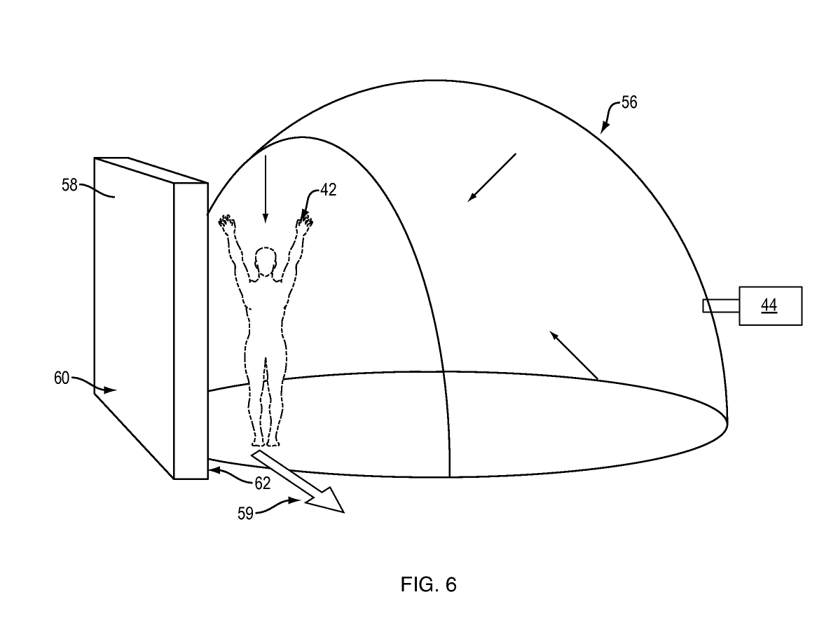

FIGS. 3 through 7 illustrate the theory behind the design of the passive millimeter wave imaging system 100 (FIG. 6) having a smaller-than perfect, but still effective environment, as described herein.

FIG. 3 illustrates an ideal, spherically-shaped passive imaging radiometer environment 40. In this illustration, a subject 42 is immersed entirely within an ideal radiometric environment 40 where the same environmental temperature 46 is present in every direction from the subject 42. For example, the environment 40 can be held at one temperature that is different from, or lower than, the surface temperature of the subject 42. It should be noted that the temperature of the environment 40 may be higher than that of the subject 42 without loss of general effectiveness. As illustrated, the subject 42 is suspended in the middle of the spherical environment 40 which is difficult to achieve in practical terms. However, with this environment 40, a sensor 44 can detect a contrast between the body of the subject and the lower environmental temperature which is being reflected by a concealed object. Because the same environmental temperature 46 is available in all directions, whatever the position or orientation of a concealed object relative to the subject 22, it is likely to reflect the environmental temperature 46 back to the sensor 44.

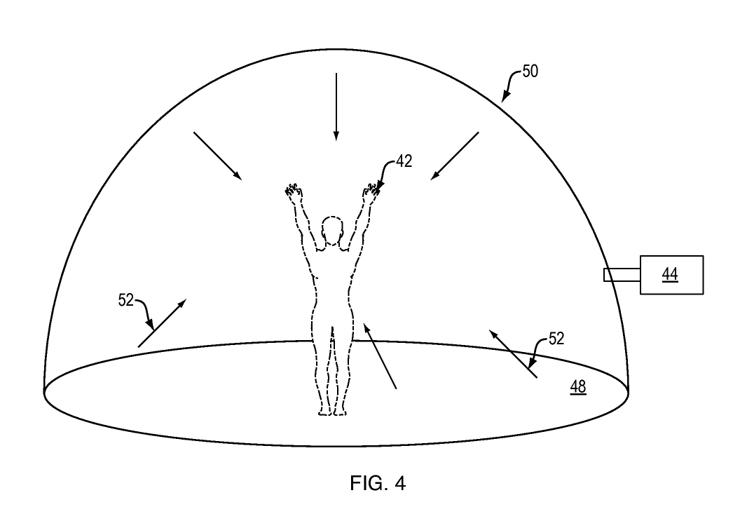

In FIG. 4, a modification to the environment of FIG. 3 shows a mirror 48 replacing one half of the spherically-shaped environment 40 to provide a radiometric environmental thermal envelope 50, as well as a support surface for the subject 42. In general, placement of a mirror 48 at floor level provides a good substitute for a perfect spherical environment, as the mirror reflects the temperature from the environment 40, as indicated by arrows 52. One potential drawback is a reflection of the subject 42 by the mirror.

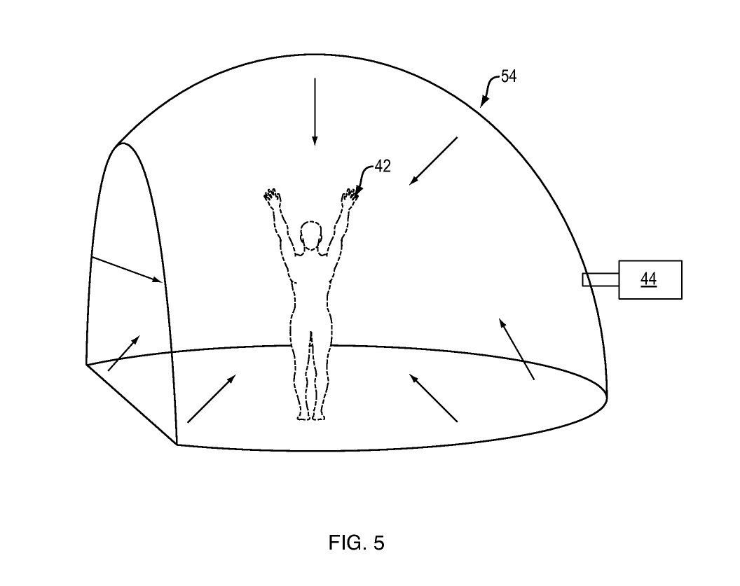

FIG. 5 illustrates a modification of the environment 52 of FIG. 4 which allows the subject 42 to enter and leave the environment chamber 54 and which reduces the size of the environment 52 to make the shape more practical for space-constrained areas. This modification, which effectively adds an opening to the environment 54, may reduce the effectiveness of the system of FIG. 4 for two reasons. The first is that clutter from objects outside of the influence of the sphere may appear in the sensors image in the background behind the subject 42. The second issue is that there may be some angles for which a reflective object might also be illuminated from outside of the environment 54 and into the sensor 44. By placing the opening essentially behind the subject 42, some of the loss of effectiveness due to the second issue can be mitigated.

FIG. 6 illustrates a modification of the environment 54 of FIG. 4 where the environment 56 includes the addition of a wall 58. This wall 58 can also be thermally controlled so that it provides an appropriate thermal environment for the background for the sensor 44 (thereby eliminating the first reduction in effectiveness discussed regarding FIG. 5, above) and for illuminating objects which are concealed. In addition, this wall 58 provides a natural direction of flow 59 for the subject 42. Accordingly, there may be a first side 60 of the wall structure 58 where subjects 42 are not scanned and a second side 62 of the wall structure 58 where subjects 42 are subject to a scan.

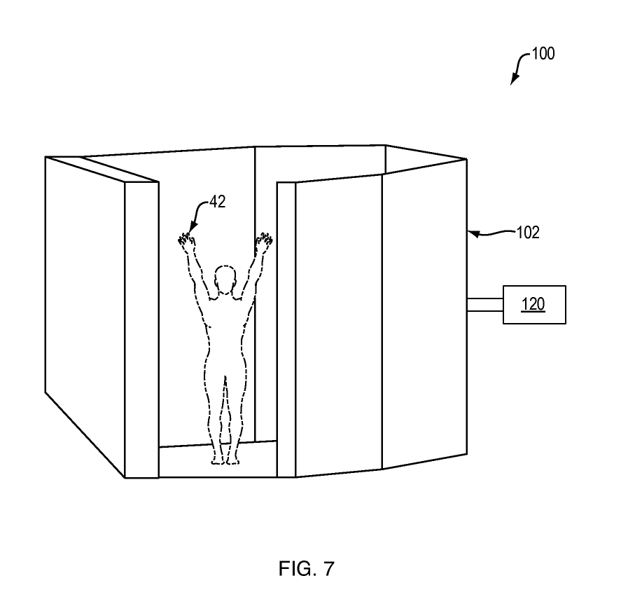

Based upon the developmental theory provided above, FIG. 7 illustrates a schematic depiction of a passive millimeter wave imaging system 100. The system 100 includes an environment 102 and a sensor 115. The system 100 is configured as a substantially rectilinear structure, such as illustrated, which serves the purpose of the curved surfaces presented in the development above. Changing from a substantially round structure to the more rectilinear walls does not change the effective radiometric environment. Instead the rectilinear walls simplify construction of the environment 102, as rectilinear structures are generally, and practically, easier to construct. The geometry of the passive millimeter wave imaging system 100 along with the temperature difference between the environment 102 and the subject 42 (e.g., the lower-than normal temperature of the system's environment 102) is configured to increase the imaging contrast between the subject 42 and any concealed or reflective objects carried by the subject 42 to maximize the likelihood of detection of the objects. It should be noted that description of the rectilinear structure is by way of example, only. In one arrangement, curved surfaces can be utilized as part of the passive millimeter wave imaging system 100. Additionally, the geometry of the passive millimeter wave imaging system 100 positions the subject 42 closer to the sensor 115, relative to conventional systems, to maximize the angles with which a concealed object is likely to reflect the controlled environment temperature.

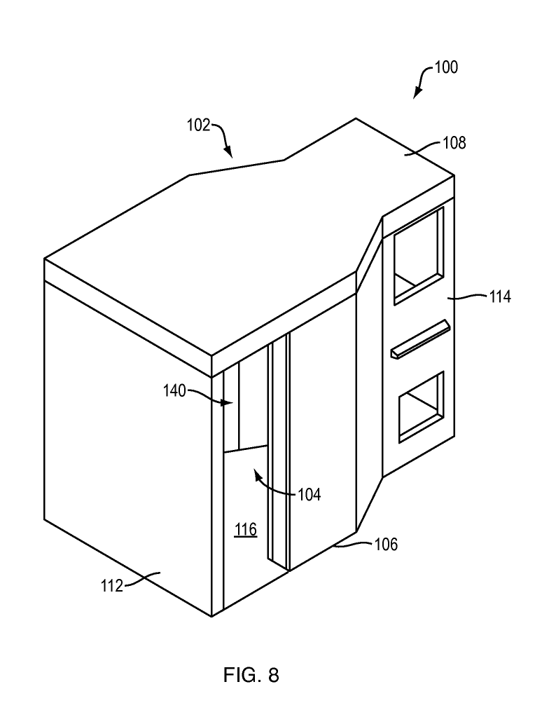

While the passive millimeter wave imaging system 100 can be configured in a variety of ways, FIGS. 8-11 illustrate an example of the system 100 wherein a number of sections of the environment 102 can be constructed and then assembled into a rectilinear structure to form the system 100.

For example, the system 100 includes a sensor section 114 and an environment 102 having first and second side wall sections 104, 106, a ceiling section 108, an imaging section 110, a third or back wall section 112, and a floor section 116. The sensor section 114 includes, for example, a passive millimeter wave imager or sensor 115 and a video camera, each disposed in electrical communication with a computerized device, such as a conventional laptop or personal computer with a screen display.

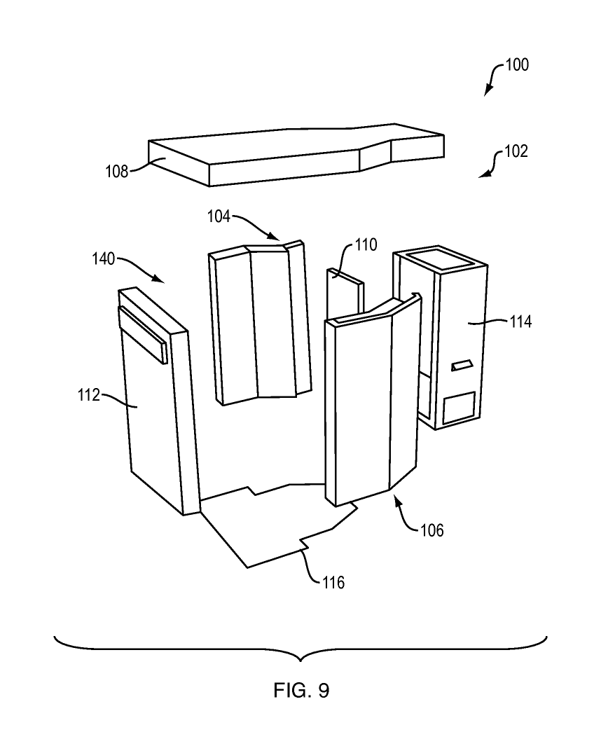

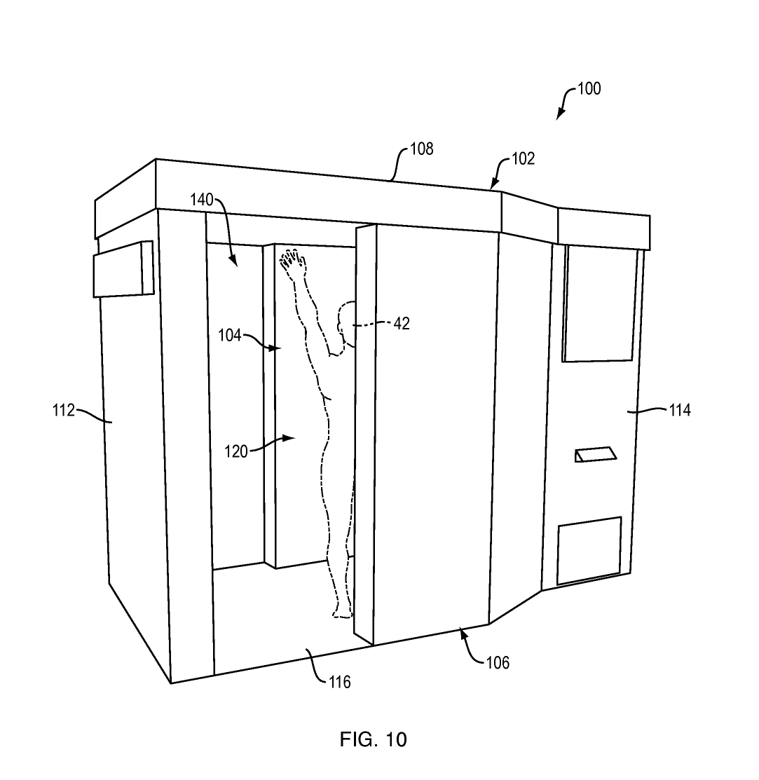

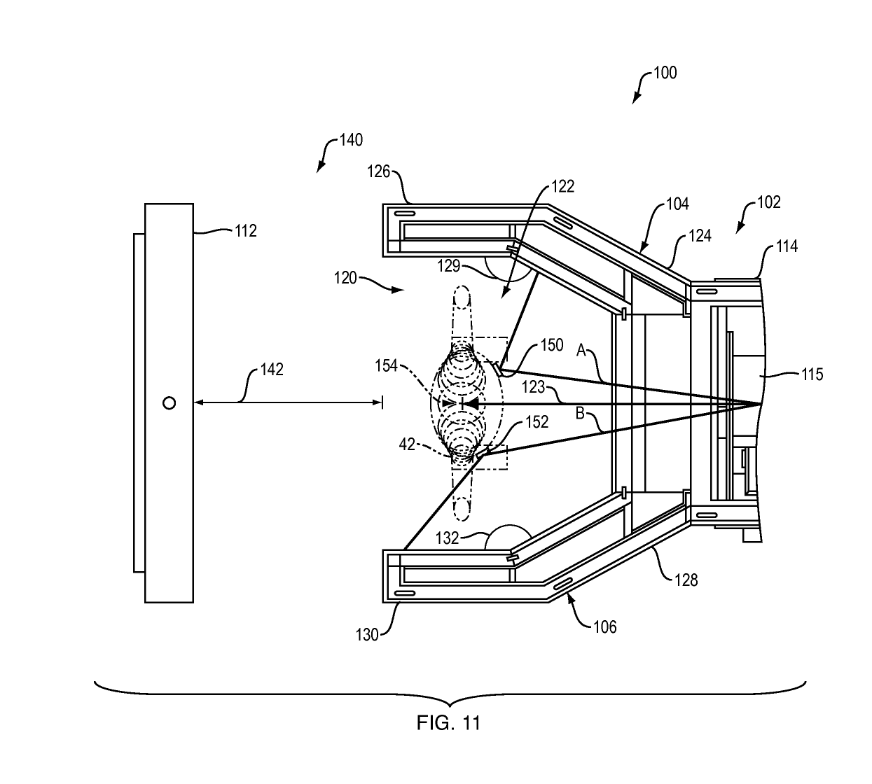

The first and second walls 104, 106 extend from the sensor location 114 and, as illustrated in FIGS. 10 and 11, are configured to substantially surround a subject imaging location 120 disposed at a focal distance 123 from the sensor 114. For example, with reference to FIGS. 9 and 11, the first wall 104 defines a first substantially arc-shaped structure having a first wall portion 124 extending from the sensor location 114 and a second wall portion 126 extending from the first wall portion 124 toward the third wall 112. The second wall portion 126 is disposed at an angle 128 relative to the first wall portion 124 to define the first substantially arc-shaped wall 104. Additionally, with continued reference to FIGS. 9 and 11, the second wall 106 defines a second substantially arc-shaped structure having a first wall portion 128 extending from the sensor location 114 and a second wall portion 130 extending from the first wall portion 128 toward the third wall 112. The second wall portion 130 is disposed at an angle 132 relative to the first wall portion 128 to define the second substantially arc-shaped wall 106 where the second wall portion 130 of the second wall 106 is substantially parallel to the second wall portion 126 of the first wall 104.

In use, once a subject 42 enters the system 100, the subject 42 stands at the subject imaging location 120. With such positioning at the imaging location 120, the subject 42 is disposed at the focal distance 123 from the sensor 115 which allows the sensor 115 to detect the presence of a concealed object along the entire height of the subject 42 and with the subject 42 being in focus relative to the sensor 115. Additionally, with such positioning the geometric configuration of the first and second walls 104, 106 substantially surround and encompass the subject 42 which maximizes the ability for the system 100 to detect a concealed object 124 while minimizing the overall footprint of the system 100.

The third wall 112 is disposed at a distance from the side wall sections 104, 106 and opposes the sensor section 114. The third wall 112 is configured to reduce the visual confinement of a subject 42 while enhancing the detection of potential threats. As illustrated in FIGS. 8-11, the third wall 112 defines a subject walk space 140 relative to the first wall 104 and the second wall 106. For example, the third wall 112 defines the walk space 140 having about a thirty-six inch width 142 relative to the first and second walls 104, 106. With such a configuration, the third wall 112 aids in directing subjects to the subject imaging location 120 while maximizing the ability for the system 100 to detect a concealed object 124 as carried by the subject 42.

The geometric configuration of the passive millimeter wave detection system 100 aids in increasing the imaging contrast between the subject 42 and concealed or reflective objects carried by the subject to maximize the likelihood of detection of the objects, relative to the conventional passive millimeter-wave imager. Additionally, the dimensions of the passive millimeter wave detection system 100 provides a relatively compact design for easy installation in varied venues such as mass transportation hubs, shopping malls, and entryways to public buildings.

The first, second, and third walls 104, 106, 112 are configured to provide a thermal environment having an environmental temperature which is distinct from a subject temperature. For example, the first, second, and third walls 104, 106, 112 can be held at one temperature that is different from, (e.g., is lower than), the surface temperature of the subject 42. With such a configuration, radiometric emissive materials within the imaging location 120 take on the temperature of the first, second, and third walls 104, 106, 112 which allows the environment 100 to provide the appropriate radiometric environment for the contrast necessary for the sensor 114 concealed object detection.

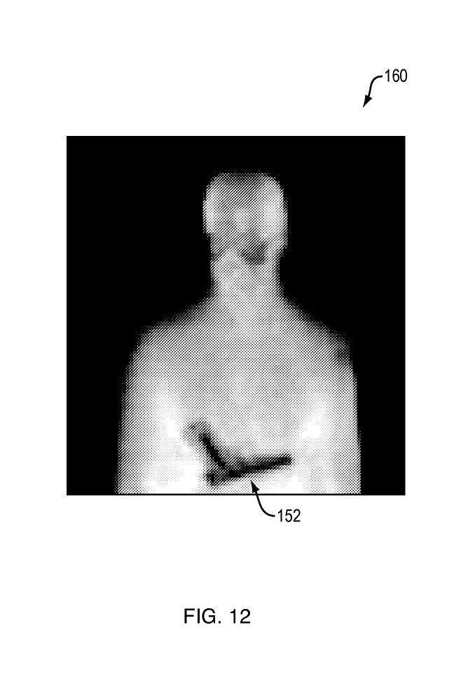

FIG. 11 illustrates the method by which concealed objects can be revealed by the passive millimeter-wave imaging system 100, for example. In this example, the subject 42, a gray body, is very emissive and not very reflective. First and second objects 150, 152, such as concealed handguns, are very reflective and have almost zero emission. The intervening clothing (not shown) worn by the subject 42 is nearly transparent to the passive millimeter-wave imaging system 100. The environment 102 in which the subject 42 is immersed has a radiometric temperature that is different (e.g., significantly lower) than the human body, such as a temperature of 40° F., for example. During operation, the subject 42 appears to the sensor 115 at a radiometric temperature close to 92° F. The first object 150 reflects the low-temperature wall 104 into the sensor 115 as depicted by line A. The second object 152, for instance, reflects the low-temperature wall 106 into the sensor 115 as depicted by line B. If the subject 42 is asked to turn around about axis 154, the probability is very high that any object 150, 152 concealed on the subject 42 will be revealed to the sensor 115 in such a fashion that at some point in the subject's rotation every concealed object will reflect a cold wall 104, 106 to the sensor 115. As the subject 42 is emissive, the objects are 150, 152 are reflective, the difference between the radiometric temperature of the environment 100 and the subject 42 creates a contrast in the resulting image 160, as generated by the sensor section 114 and illustrated in FIG. 12. The contrast is only slightly reduced by the intervening clothing worn by the subject. Note that environment temperatures other than 40° F. can give rise to contrast and this value is used herein only as an example environment temperature. There may be advantages gained by using lower or higher temperatures and the descriptions and embodiments herein are general and accommodate other temperatures.

In a like manner, the ceiling section 108 of the environmental enclosure 100, as supported by the first, second, and third walls 102, 104, 106, may also be reflected by an object into the sensor 120 depending on angles which would reflect in such a direction, thereby revealing objects with such orientations. In one arrangement, the ceiling section 108 can be configured to provide a thermal environment having an environmental temperature that is distinct from the subject temperature and that is substantially similar to the thermal environment provided by the first, second, and third walls 102, 104, 106. For example, the ceiling section 108 can be configured with a radiometric temperature that is different (e.g., significantly lower) than the subject 42, such as a temperature of 40° F. During operation, a concealed object carried by the subject 42 can reflect the low-temperature ceiling section 108 into the sensor 115. In another arrangement, the ceiling section 108 can be configured as a ceiling mirror supported by the first wall 102, the second wall 104, and the third wall 106.

As indicated above, the system 100 includes a floor section 116, which can be configured in a variety of ways. In one arrangement, the floor section 116 is configured as a mirror disposed at least within the subject imaging location 120 defined by the first wall 104 and the second wall 106. For example, the mirrored floor section 116 provides a radiometric environmental thermal envelope for the subject 42 and reflects the temperature from the environment 102. In one arrangement, the floor section 106 is configured to provide a thermal environment having an environmental temperature which is substantially similar to the thermal environment provided by the first wall 104, the second wall 106, and the third wall 112. For example, the floor section 106 can be configured with a radiometric temperature that is different (e.g., significantly lower) than the subject 42, such as a temperature of 40° F.

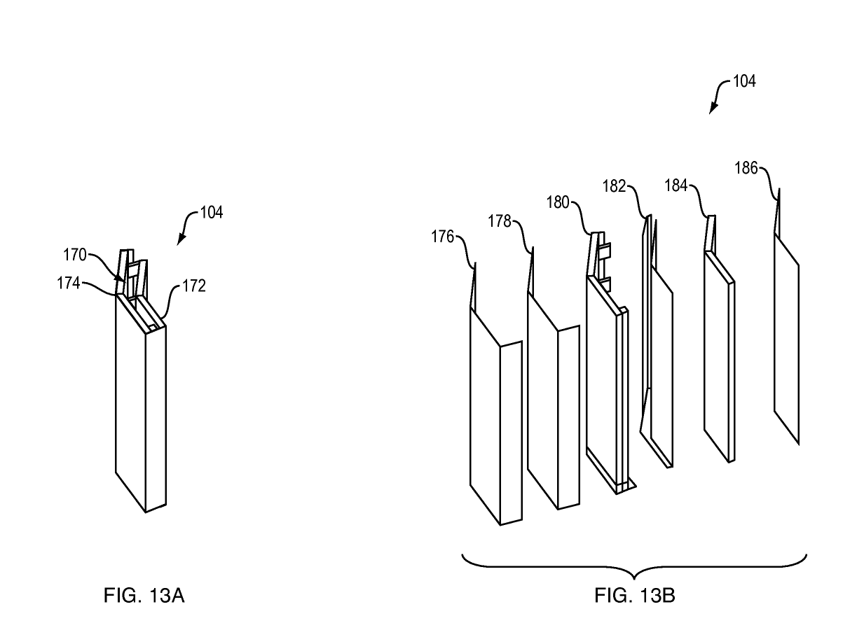

As indicated above, the first, second, and third walls 104, 106, 112, as well as the ceiling section 108 and the floor section 116, can be held at a different temperature than the subject 42. In one arrangement, each of the first and second side wall sections 104, 106, ceiling section 108, imaging section 110, and back wall section 112 is configured with internal passages or conduits for the flow of chilled. For example, with reference to FIG. 13A, the first wall 104 defines a conduit 170 between a first wall element 172 and a second wall element 174. The conduit 170 is configured to carry a fluid, such as turbulent chilled air, which causes the first wall 104 to provide the thermal environment having an environmental temperature, such as a relatively low temperature relative to the subject. With such a configuration, the environment 102 of the system 100 takes on the temperature of the chilled air which allows the system 100 to provide the appropriate radiometric environment for the contrast necessary for concealed object detection.

As indicated above, the first and second side wall sections 104, 106, roof section 108, imaging section 110, and floor section 116, and back wall section 112 can be configured with internal passages for the flow of chilled air. In one arrangement, a variety of different materials can be utilized to manufacture the sections.

In one arrangement, three general types of materials are utilized for the construction of the passive millimeter wave detection system 100. For example, the sections are constructed of materials which exhibit strength and are substantially transparent to millimeter wavelengths, materials which exhibit thermal insulation and are substantially transparent to millimeter wavelengths, and materials which exhibit highly emissive millimeter wavelength properties.

For example, materials used for internal rigid components to support structures and/or materials which can be used for external surfaces which may be subjected to normal wear and tear abuses should exhibit strength and are substantially transparent to millimeter wavelengths. Materials which fulfill these requirements are generally plastics. In one arrangement, thermoplastics can be used for external surfaces. However, in order to be effective as highly transparent to millimeter wavelengths, their exact thickness must be selected so that they are some number of half wavelengths at the frequency of interest and the velocity factor of the material. For example, in the case of operation at W-band, most thermoplastics must be selected with a thickness which is a multiple of about 40 thousandths of an inch or approximately 1 mm. In one arrangement, KYDEX, a trademarked product from KYDEX LLC, is provided in such a thickness and is available in a variety of colors. However, other materials with similar properties can be employed for this purpose. Regarding internal rigid components, in one arrangement, products which are primarily constructed of low density polyethylene (LDPE) and high density polyethylene (HDPE) in various thicknesses, including one-eighth inch thick can be utilized.

Certain materials, such as plastic foams, exhibit thermal insulation yet are substantially transparent to millimeter wavelengths. For example, polystyrene foam materials, such as those materials which do not have fire retardant additives, are substantially transparent to millimeter wavelengths, particularly in the case of operation at W-band. Polystyrene foam is also configured to provide thermal insulation.

Highly emissive millimeter wavelengths materials have been designed and effectively marketed by several companies primarily interested in absorbing radiofrequency emissions. These materials are often used in electronics manufacturing, on the walls of anechoic chambers, and in other various industrial and military applications. Materials which are good absorbers are also emissive. Highly emissive millimeter wavelength materials reveal a radiometric temperature close or equal to their physical temperature. In one arrangement, highly emissive millimeter wavelengths materials such as radar absorbing materials (RAMs) can be used in the system 100. Sheets of this material can be readily attached to polystyrene foam and other surfaces using appropriate adhesives.

Although there are materials listed here which provide excellent properties as described, one studied in the art would know that there are other materials not listed here which also may provide excellent properties. The materials described herein are examples and are not meant to exclude other potential materials for the construction of systems described herein. Use of different materials than these, but which have similar properties, may be understood by one studied in the art to implement or and body essentially the same invention.

FIG. 13B depicts an example construction of one of the environment sections, such as first wall section 104 wherein a number of layers are used. The outside layer 176 may be any decorative material such as decorative laminate (e.g., Formica) or metal. Directly interior from that is the primary structural member 178. While the member 178 can be constructed from a variety of materials, in one arrangement, the member is formed of plywood. Directly inside of this is an insulating foam material 180 which may be of any practical quality type of insulation as its millimeter wave properties (or the properties of this material at the wavelength of interest for radiometric imaging) are substantially not relevant. The insulating foam material 180 defines the chamber 170 through which the turbulent, chilled air circulates. Next, is a layer of a substantially emissive and substantially non-reflective material 182 which is configured to be exposed to a thermal change by the fluid and which is configured to provide the thermal environment having the environmental temperature based upon the thermal change. For example, the material 182 can be configured as a sheet of highly emissive radar absorbing material (RAM) 182. With such a configuration, the RAM takes on the temperature of the circulating air which allows the environment sections 102 to provide the appropriate radiometric environment for the contrast necessary for concealed object detection.

The next layer is polystyrene foam or any high quality thermal insulator 184 which is transparent to the radiometric wavelengths appropriate to the imaging system 100 (e.g., millimeter waves). The next layer 186 is an inner wall portion configured to face a subject 42 and is configured as a substantially millimeter wavelength transparent material. For example, the layer can be configured as a thin sheet of plastic 160, such as KYDEX, having a thickness selected to maximize transmission of the wavelengths appropriate to the imaging system 100 while providing structural rigidity. It can be noted that the RAM 156 may be placed upon either interior insulation surface 154 or 158 with approximately equal effectiveness. Furthermore, RAM 156 may be placed on both interior surfaces. In a similar fashion, the other sections (i.e., second side wall section 106 and roof section 108) can be constructed. In one arrangement, structural and rigid foam members can be added within the chamber 162 to keep the airspace from collapsing, to aid in overall rigidity, and to provide baffling in order to direct chilled air most effectively.

While various embodiments of the invention have been particularly shown and described, it will be understood by those skilled in the art that various changes in form and details may be made therein without departing from the spirit and scope of the invention as defined by the appended claims.

As indicated above, the back wall section 112 is configured to have its temperature controlled. In one arrangement, the back wall section 112 is heated, such as to a temperature of 80° F., to emit a similar radiation as the human subject to be scanned.

In another arrangement, the passive millimeter wave detection system 100 can include wall extension portions, such as one or more chilled wall extensions, which can be removeably disposed in proximity to the walk space 140 defined by the first and second wall sections 104, 106 to further enhance the effectiveness of the passive millimeter wave detection system 100.

As indicated above, the ceiling portion 108 is described as being configured to provide a thermal environment having an environmental temperature to the subject 42 or can be configured as a mirror. Such description is by way of example only. In one arrangement, the ceiling portion 108 can be configured as both a mirror and as a structure that provides a thermal environment having an environmental temperature to the subject 42. In one arrangement, the ceiling portion 108 can also be configured as a temporary (i.e., removable) structure.

As indicated above, the floor portion 116 is described as being configured to provide a thermal environment having an environmental temperature to the subject 42 or can be configured as a mirror. Such description is by way of example only. In one arrangement, the floor portion 111 can be configured as both a mirror and as a structure that provides a thermal environment having an environmental temperature to the subject 42. In one arrangement, the floor portion 116 can also be configured as a temporary (i.e., removable) structure.

In one arrangement, the system 100 includes a lighting system configured to deliver light to the subject imaging location 120. Conventional lighting systems can provide light within a passive millimeter wave imaging system, but can also add heat to the system, which can adversely affect detection of contraband objects. In one arrangement, the system 100 includes a set of fiber light bundles which deliver light from a location external to the subject imaging location 120. The fiber light bundles provide illumination to the subject imaging location 120 while minimizing disturbances in the environment temperature which might otherwise be caused by an increase in heat from hot light sources in the subject imaging location 120 or the build-up of localized hot spots within the subject imaging location 120.

What is claimed is:

1. An imaging system, comprising:
a sensor; and
an environment disposed in proximity to the sensor, the environment comprising:
a first wall extending from a sensor location and a second wall extending from the sensor location, the second wall opposing the first wall, the first wall and the second wall defining, and substantially surrounding, a subject imaging location disposed at a focal distance from the sensor; and
a third wall disposed at a distal location relative to the first wall and the second wall and opposing the sensor, the third wall defining a subject walk space relative to the first wall and the second wall;
the first wall, the second wall, and the third wall configured to provide a thermal environment having an environmental temperature, the environmental temperature being distinct from a subject temperature.

2. The imaging system of claim 1, further comprising a ceiling supported by the first wall, the second wall, and the third wall, the ceiling configured to provide a thermal environment having an environmental temperature, the environmental temperature being distinct from the subject temperature and being substantially similar to the thermal environment provided by the first wall, the second wall, and the third wall.

3. The imaging system of claim 1, further comprising a ceiling mirror supported by the first wall, the second wall, and the third wall.

4. The imaging system of claim 1, further comprising a floor portion disposed at least within the subject imaging location defined by the first wall and the second wall, the floor portion configured to provide a thermal environment having an environmental temperature, the environmental temperature being distinct from the subject temperature and being substantially similar to the thermal environment provided by the first wall, the second wall, and the third wall.

5. The imaging system of claim 1, further comprising a mirror disposed at least within the subject imaging location defined by the first wall and the second wall.

6. The imaging system of claim 1, wherein:
the first wall defines a first substantially arc-shaped structure extending from the sensor location toward the third wall; and
the second wall defines a second substantially arc-shaped structure extending from the sensor location toward the third wall.

7. The imaging system of claim 6, wherein:
the first wall comprises a first wall portion extending from the sensor location and a second wall portion extending from the first wall portion, toward the third wall the second wall portion disposed at an angle relative to the first wall portion to define the first substantially arc-shaped structure; and
the second wall comprises a first wall portion extending from the sensor location and a second wall portion extending from the first wall portion toward the third wall, the second wall portion disposed at an angle relative to the first wall portion to define the substantially arc-shaped structure, the second wall portion of the second wall being substantially parallel to the second wall portion of the first wall.

8. The imaging system of claim 1, wherein at least one of the first wall, the second wall, and the third wall defines a conduit between a first wall element and a second wall element, the conduit configured to carry a fluid, the fluid configured to cause the at least one of the first wall, the second wall, and the third wall to provide the thermal environment having the environmental temperature, the environmental temperature being distinct from the subject temperature.

9. The imaging system of claim 8, wherein the at least one of the first wall, the second wall, and the third wall comprises a substantially emissive and substantially non-reflective material configured to be exposed to a thermal change by the fluid and to provide the thermal environment having the environmental temperature based upon the thermal change.

10. The imaging system of claim 9, wherein the substantially emissive and substantially non-reflective material comprises a radar absorbing material.

11. The imaging system of claim 1, wherein at least one of the first wall, the second wall, and the third wall defines an outer wall portion and an inner wall portion, the inner wall portion facing the subject imaging location, the inner wall portion comprising a substantially millimeter wavelength transparent material.

12. An environment configured to be disposed in proximity to an imaging sensor, the environment comprising:
a first wall extending from a sensor location and a second wall extending from the sensor location, the second wall opposing the first wall, the first wall and the second wall defining, and substantially surrounding, a subject imaging location disposed at a focal distance from the sensor; and
a third wall disposed at a distal location relative to the first wall and the second wall and opposing the sensor, the third wall defining a subject walk space relative to the first wall and the second wall;
the first wall, the second wall, and the third wall configured to provide a thermal environment having an environmental temperature, the environmental temperature being distinct from a subject temperature.

13. The environment of claim 12, further comprising a ceiling supported by the first wall, the second wall, and the third wall, the fourth wall configured to provide a thermal environment having an environmental temperature, the environmental temperature being distinct from the subject temperature and being substantially similar to the thermal environment provided by the first wall, the second wall, and the third wall.

14. The environment of claim 12, further comprising a ceiling mirror supported by the first wall, the second wall, and the third wall.

15. The environment of claim 12, further comprising a floor portion disposed at least within the subject imaging location defined by the first wall and the second wall, the floor portion configured to provide a thermal environment having an environmental temperature, the environmental temperature being distinct from the subject temperature and being substantially similar to the thermal environment provided by the first wall, the second wall, and the third wall.

16. The environment of claim 12, further comprising a mirror disposed at least within the subject imaging location defined by the first wall and the second wall.

17. The environment of claim 12, wherein:
the first wall defines a first substantially arc-shaped structure extending from the sensor location toward the third wall; and
the second wall defines a second substantially arc-shaped structure extending from the sensor location toward the third wall.

18. The environment of claim 17, wherein:
the first wall comprises a first wall portion extending from the sensor location and a second wall portion extending from the first wall portion, toward the third wall the second wall portion disposed at an angle relative to the first wall portion to define the first substantially arc-shaped structure; and
the second wall comprises a first wall portion extending from the sensor location and a second wall portion extending from the first wall portion toward the third wall, the second wall portion disposed at an angle relative to the first wall portion to define the substantially arc-shaped structure, the second wall portion of the second wall being substantially parallel to the second wall portion of the first wall.

19. The environment of claim 12, wherein at least one of the first wall, the second wall, and the third wall defines a conduit between a first wall element and a second wall element, the conduit configured to carry a fluid, the fluid configured to cause the at least one of the first wall, the second wall, and the third wall to provide the thermal environment having the environmental temperature, the environmental temperature being distinct from the subject temperature.

20. The environment of claim 19, wherein the at least one of the first wall, the second wall, and the third wall comprises a substantially emissive and substantially non-reflective material configured to be exposed to a thermal change by the fluid and to provide the thermal environment having the environmental temperature based upon the thermal change.

21. The environment of claim 20, wherein the substantially emissive and substantially non-reflective material comprises a radar absorbing material.

22. The environment of claim 12, wherein at least one of the first wall, the second wall, and the third wall defines an outer wall portion and an inner wall portion, the inner wall portion facing the subject imaging location, the inner wall portion comprising a substantially millimeter wavelength transparent material.
